(19) United States
(12) Patent Application Publication
(10) Pub. No.: US 2007/0266117 A1
(43) Pub. Date: Nov. 15, 2007

(54) Method And System For Managing And Linking Machines With Users Or Other Machines Which Are Remote

(75) Inventors: Stephane Pomies, Lunel-Viel (FR); Romain Lotoux, Montpellier (FR); Francois Catagnia, Montpellier (FR)

Correspondence Address: YOUNG & THOMPSON, 745 SOUTH 23RD STREET, 2ND FLOOR, ARLINGTON, VA, 22202, US

(73) Assignee: OKATLOGIC, MONTPELLIER CEDEX (FR)

(21) Appl. No.: 11/662,412

(22) PCT Filed: Sep. 13, 2005
(86) PCT No.: PCT/FR05/02271

§ 371 Date: Mar. 9, 2007

(30) Foreign Application Priority Data
Sep. 13, 2004 (FR) 0409696

(51) Int. Cl. G06F 15/16

(52) U.S. Cl. 709/218

(57) ABSTRACT

Method and system of managing and linking fixed or mobile machines with users or other machines that are remote. The invention also relates to a system includes at least one machine device (D) which is connected to a given machine, a central co-ordinator (C) and at least one fixed or mobile station (P) belonging to a given user. Each machine device (D) and each user station (P) includes an element for remotely connecting to the central co-ordinator and for generating algorithms that are intended to maintain a permanent transmission using a proprietary communication protocol, whereby communication between a machine device and the central co-ordinator is wireless. The central co-ordinator (C) includes a server-type unit which can instantaneously and simultaneously process orders intended for the machines and enable each machine to access a common database.

### FIELD OF THE INVENTION

The invention relates to a method for managing and linking machines with users or other machines which are remote, intended to collect, transfer, analyze, diagnose and store technical data provided by said machines. The invention also relates to a system implementing this method.

### TECHNOLOGICAL BACKGROUND

The known systems intended to manage and link machines with remote users generally include:

a) at least one electronic device, connected to a given machine which is fixed or mobile, essentially comprising means for calculation, management, storage, remote communication, connection to the different sensors of the machine concerned and specific recorded programs; said machine being of the following type: a factory production machine, mobile handling machine, a production robot, or an analysis, storage or preservation machine;

b) a central coordinator, of the IP server type, of the type comprising essentially means for calculation, management, storage, remote communication and specific stored programs;

c) at least one fixed or mobile station, belonging to a given user, of the type comprising essentially means for calculation, management, storage, remote communication and specific recorded programs.

They generally have the following drawbacks:
the communication protocols are not proprietary (lack of confidentiality) and are not protected by algorithms (lack of reliability);
all the redundant technical data are recorded (large storage memories);
the localization of a mobile machine consists in the reading of its GPS position (“Global Positioning System”), its saving in a local file and the transfer of the file (once it has reached the required size and/or every n minutes) to the hosted central server (before being transferred to the final user) in other words the exchanges are not instantaneous and the coordinator is not notified immediately and therefore cannot carry out the checks and interact in real time;
it is not possible to establish a correspondence between the technical data (machine sensors) and an exchange table between the machine and the coordinator, and to transfer the table instantaneously in order to view the machine information in real time from a remote user interface.

The purpose of the invention is to propose a method and a system of the sort in question which does not comprise the above-mentioned drawbacks.

### DESCRIPTION OF THE INVENTION

This objective is obtained with a method for managing and linking machines with users or other machines which are remote, intended to collect and process technical data provided by said machines, comprising:
a capture of technical data by at least one machine device connected to a given machine,
at least one so-called machine communication which is remote and wireless, between a machine device and a central coordinator, of the IP server type,
at least one so-called user communication which is remote, wired or wireless, between a user station belonging to a user and the central coordinator, and
saving data,
   characterized in that it further comprises an implementation, at the level of each machine device and of each user station, of a proprietary communication protocol comprising:
a permanent maintenance of each machine communication,
a permanent maintenance of each user communication,
reducing the volume of data, and
securing the saving of data.

Preferably, a machine communication is of the GPRS type (“General Packet Radio Service”).

The method according to the invention can further comprise a dialogue of one or more users with one or more machines.

The saving of data can comprise a recording of technical data and of associated timestamp data.

The saving of data can comprise:
a transmission, by machine communication, of technical data to the central coordinator, and
recording the data in a common database and/or in a subdirectory for the creation of saving files.

Securing the saving can comprise:
a detection of a fault of a machine communication between a machine device and the central coordinator, or in other words a survey of the quality of the network service,
a local recording of technical data at the level of the machine device while the machine communication is faulty, then
once the machine communication is no longer faulty, a transmission to the central coordinator of the locally recorded data, and
recording the data in a common database and/or in a subdirectory for the creation of saving files.

Reducing the data volume can comprise a cyclical implementation of the saving of data. In this case, the saving of data can record data only if said data are different to those recorded previously. Reducing the data volume can also comprise an encoding of the variation of at least one item of data on less than four octets. As mentioned previously, the saving of data can comprise a recording and a timestamping of technical data originating from the machines; reducing the data volume can therefore apply both to technical data and to the timestamping data thereof. A reduction of data volume allows a cost reduction in terms of telephony, and a rapidity of the exchanges which makes the communications more or less instantaneous.

In one embodiment, the method according to the invention can be implemented for a group of machines comprising at least one or more mobile machines and comprise locating at least one mobile machine and a transmission to the central coordinator of the location data. In this embodiment, the method according to the invention can further comprise a calculation of the instantaneous speed of at least one mobile machine, and/or an analysis by the central coordinator of geographical zones of the location data. The usefulness of such an analysis can be to alert a mobile machine located in a risky geographical zone: due to the more or less instantaneous machine and user communications, the method according to the invention allows a real time alert of such a mobile machine.

The method according to the invention can further comprise:
an establishment, at the level of a machine device, of a correspondence between technical data originating from a given machine and an exchange table between the device and the coordinator, and
a transfer of said exchange table to said coordinator.

The method according to the invention can further comprise an establishment, at the level of the central coordinator, of a correspondence between technical data originating from a given machine and an exchange table between a machine device connected to the machine and the coordinator.

The method according to the invention can further comprise:
writing, at the level of the central coordinator, of fault-detection and adjustment scripts,
sending said scripts to a machine device, and
executing said scripts at the level of the machine device.

The method according to the invention can further comprise, at the level of the central coordinator, programming and/or downloading of messaging scripts to a machine device and a management of acknowledgements.

The method according to the invention can further comprise, at the level of the central coordinator, programming and/or downloading of scripts intended to automatically establish a link between machines.

The method according to the invention can further comprise a display on at least one user station, of the technical data in graphical form or an analysis of said data by specific scripts.

The method according to the invention can further comprise, at the level of at least one user station, programming and/or downloading of messaging scripts to a machine device according to a proprietary protocol.

According to yet another feature of the invention, a system is proposed which implements the method according to the invention, comprising a central coordinator, at least one machine, at least one machine device connected to a machine, and at least one user station belonging to a user, said system essentially being characterized in that:
each machine device comprises means which are able to remotely connect it to the central coordinator, and to generate algorithms intended to permanently maintain a wireless transmission or communication which uses a proprietary communication protocol using TCP-IP making said transmission confidential and very reliable;
the central coordinator comprises means of the server type which are able instantaneously (to the second) and simultaneously (multitasking), to treat the orders intended for the machines and to allow each machine to access a common database and a subdirectory for the creation of saving files; means, also of the server type, which are able instantaneously and simultaneously (multiconnectivity), to allow one or more users to communicate with one or more selected machines and to access said common database and the subdirectory in order to read the saving files and means which are able to connect the machines together;
each user station comprises means which are able to connect it to the central coordinator and to generate algorithms intended to permanently maintain a transmission or communication, rewired or wireless, and which uses a proprietary communication protocol using TCP-IP;
   the assembly in question thus dynamically creating a restricted and confidential industrial network between machines and users, or other machines; and
the system further comprises means for securing the saving of data and reducing the data volume.

According to features of embodiments of the invention:
the means for securing the saving can comprise for each machine device means for recording and timestamping the technical data originating from the machines; the recording and timestamping means can be arranged in order to carry out a cyclic recording, and can be arranged so as to record data only if they are different from those corresponding to the last recording: the size of the memories and the reading of the data is thus considerably reduced;
each machine device comprises means for establishing a correspondence between technical data originating from a given machine and an exchange table between said device and the coordinator, and for transferring said exchange table to said coordinator;
the central coordinator comprises means which are able to instantaneously and directly establish a correspondence between technical data originating from a given machine and an exchange table between a machine device connected to the machine and the coordinator;
the central coordinator comprises means which are able to program and download messaging scripts to a device provided with display means of the interactive type or another type and to manage acknowledgements;
the central coordinator comprises means which are able to program and download scripts intended to automatically establish a link between machines;
the central coordinator comprises means for writing fault-detection and adjustment scripts and sending them to a machine device in order to remotely execute them there;
each user station comprises means which are able, instantaneously, to display the technical data in a graphical form and means which are able to analyze said data using specific scripts;
each user station comprises means which are able to program and download messaging scripts to a device provided with display means of the interactive type or another type;
the system can be implemented for a group of machines comprising at least one or more mobile machines, and can also comprise means for locating said mobile machine and for transmitting to the central coordinator location data; in this embodiment, the location means can be arranged in order to calculate the instantaneous speed of the mobile machine, and/or the central coordinator can also comprise means for analyzing the geographical zones location data and interact as a function of the information which will have been given to it;
the central coordinator can be installed directly in the company;
at least one of the machines can consist of a machine for factory production, mobile handling machine, a production robot, or an analysis, storage or preservation machine.

### PRESENTATION OF THE FIGURES

The characteristics and the advantages of the invention will be more apparent on reading the following detailed description of at least one preferred embodiment thereof given by way of a non-limitative example and represented in the attached drawings.

In these Drawings:

FIG. 1 represents a diagram of the system according to the invention comprising several machine devices, a central coordinator and several user stations;

FIG. 2 represents a more detailed diagram of an assembly comprising a machine device, a central coordinator and a user station.

### DETAILED DESCRIPTION OF THE INVENTION

An example of the method according to the invention comprises:
a capture of technical data by at least one machine device connected to a given machine,
at least one so-called machine communication which is remote and wireless, between a machine device and a central coordinator, of the IP server type,
at least one so-called user communication which is remote and wired or wireless, between a user station and the central coordinator,
saving data, and
an implementation at the level of each machine device and each user station of a proprietary communication protocol comprising:
   a) a permanent maintenance of each wireless machine communication, and a permanent maintenance of each user communication; the advantage of a proprietary protocol is that it makes every transmission confidential and very reliable;
   b) reducing the data volume;
   c) securing the saving of data.

In a preferred embodiment, the permanent maintenance of the machine and user communications can be obtained thanks to a proprietary “Keep Alive” method. Such a “Keep Alive” method has the advantage of limiting the data volume. In fact, the implementation and maintenance of permanent connections during the data exchange prevent a whole series of initiations of connections, identifications, and encapsulations and disencapsulations of data, which require time and the encoding of additional octets. Consequently, the “headers” of data communication are considerably reduced relative to standard protocols, for example of the internet, which allows a reduction of data volume.

The proprietary communication protocol can comprise other types of reduction of the data volume:
in a first embodiment, this can consist in a cyclic implementation of the saving of data: preferably, the saving of data records data only if said data are different from those recorded previously. Thus, the total volume of the data is considerably reduced;
in a second embodiment, it is possible to take advantage of the fact that some technical data varies over known intervals which can, according to the desired precision, be divided into a certain number of units. The variation of this type of data is then monitored by sending the number of variations relative to the last value or relative to a median value. Thus, with the correct choice of the variation unit it is possible to encode the variation of two items of data on a single octet: for example, the three first bits of an octet serve to define the variation value of the first item of data, the fourth bit defines the sign of the varition of the first item of data, the fifth, sixth and seventh bits serve to define the variation value of the second item of data, and the eighth bit defines the sign of the variation of the second item of data. It is thus possible to describe variations of plus or minus 7 units (001, 010, 011, 100, 101, 110, 111) for two values on a single octet. Similarly, by encoding a single value per octet, it is possible to achieve a precision of plus or minus 127 units. By encoding it on two octets, a precision of plus or minus 32,767 units is achieved. A saving is thus retained relative to the simple sending of a floating number encoded in a standard manner on 4 octets. This embodiment allows in particular very high sampling frequencies. Moreover, this embodiment of reducing the data volume can be applied to the timestamping of data; this timestamping then takes place on a reduced number of bits, and is not defined by a date but by a variation of a time unit;

these two embodiments being able to be combined. Preferably, the embodiments of reducing the data volume are implemented in a dynamic manner, i.e. an item of data is not stored entirely before being compressed. Preferably, the saving of data comprises:
a transmission, by machine communication, of technical data to the central coordinator, and
recording of the data in a common database and/or in a subdirectory for the creation of saving files.
   However, a GPRS type network in which a machine communication could be carried out is never totally immune to a cut. This is why the proprietary communication protocol can comprise
   a step of securing the saving of data which can take the following form:
a detection of a fault of a machine communication between a machine device and the central coordinator,
a local recording of technical data at the level of the machine device while the machine communication is faulty, then
once the machine communication is no longer faulty, a transmission to the central coordinator of the data recorded locally, and
a recording of the data in a common database and/or in a subdirectory for creation of saving files.
   Thus, a method according to the invention allows a transfer and a confidential, rapid, economical and secure updating of the data. A plurality of machine and user communications which are simultaneous, permanent and of low volumes (and therefore rapid and virtually instantaneous) gives to the method according to the invention a characteristic of permanent and real time multi-connectivity.

We will now describe an example of a system implementing the method according to the invention.

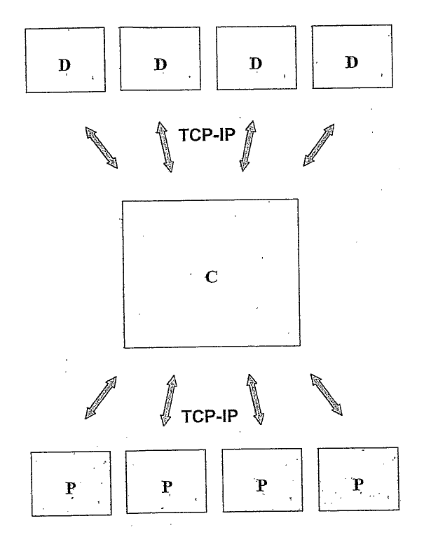

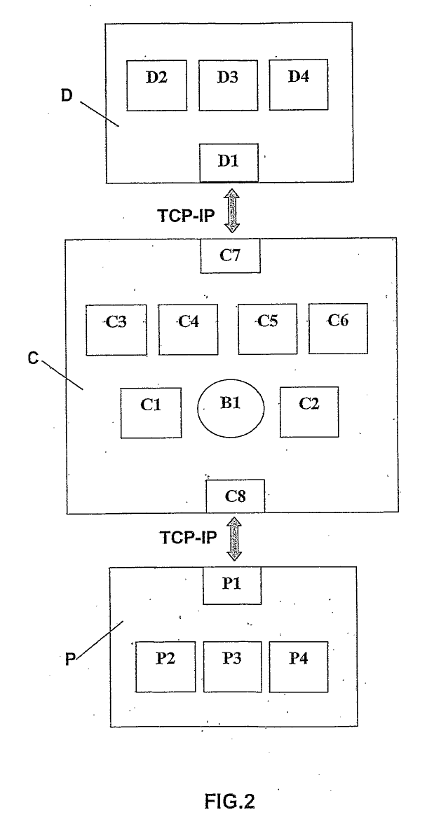

The system represented in FIGS. 1 and 2 is of the sort generally comprising:
at least one electronic device (D) (also called a machine device), connected to a given machine which is fixed or mobile, essentially comprising means for calculation, management, storage, remote communication, connection to the different sensors of the machine concerned and specific recorded programs; said machine being of the following type: a factory production machine, mobile handling machine, a production robot, or an analysis, storage or preservation machine;
a central coordinator (C), of the IP server type, of the type essentially comprising. means for calculation, management, storage, remote communication and specific recorded programs;
at least one fixed or mobile station (P), belonging to a given user, of the type essentially comprising means for calculation, management, storage, remote communication (P1) and specific recorded programs.
   Each machine device (D) comprises means (D1) which are able to remotely connect it to the central coordinator (C) and to generate algorithms intended to permanently maintain the transmission which uses a proprietary communications protocol using TCP-IP.
   The central coordinator (C) comprises means (C1), of the server type which are able to instantaneously and simultaneously process the orders intended for the machines and to allow access for each machine to a common database (B1) and to a subdirectory for the creation of saving files; means (C2), also of the server type, which are able to instantaneously and simultaneously allow each user to communicate with one or more selected machines and to access the common database (B1) and the subdirectory in order to read the saving files and means which are able to connect the machines together.
   Each user station (P) comprises means (P1) which are able to remotely connect it to the central coordinator (C) and to generate algorithms intended to permanently maintain the transmission which uses a proprietary communication protocol using TCP-IP.
   Each machine device (D) comprises:
means (D2) which are able to instantaneously record and timestamp technical data originating from the machines only if they are different from those corresponding to the last recording, the reading of data and the recording thereof being cyclical;
means (D3) which are able to instantaneously locate, by means of a GPS type system, the mobile machines, to calculate their instantaneous speed, to record the GPS points at variable frequency in a memory table and to transmit the tables to the coordinator (C); an example of the system according to the invention, maintaining all machine or user communication permanent and virtually instantaneous, makes it possible to update the GPS position of mobile machines every two seconds, in the context of their retransmission by GPRS;
means (D4) which are able to instantaneously establish a correspondence between technical data (sensors) originating from a given machine and an exchange table between said device (D) and the coordinator (C) and to transfer (for example cyclically with a possible parameterization in seconds) said exchange table to said coordinator making it possible to view the machine information in real time from a remote user interface; it is also possible to establish a correspondence between the sensors and the exchange table from the central coordinator; the means (D4) guaranteeing the reliability of the data and the display of the latter instantaneously from any user interface;
means which are able to receive multimedia data and to view them.
   The coordinator central (C) comprises:
means (C3) which are able to instantaneously analyze the geographical zones location data and to interact according to the information which will have been given to it;
means (C4) which are able to instantaneously and directly establish a correspondence between the sensors of the machine and the exchange table;
means (C5) which are able to write fault-description and adjustment scripts and to send them to a given device (D) in order to be executed remotely; said means also making it possible to set the alert mode (SMS, e-mail, direct user, etc); for each alert device a table of recipients is created;
means (C6) which are able to program and download messaging scripts to a device (D) provided with display means and to manage acknowledgements; it is thus possible to write messaging scripts according to a proprietary protocol;
means (C7) and (C8) which are able to remotely connect it to each device (D) and to each user station (P) respectively;
means which are able to program and download scripts. which are able to automatically establish a link between machines.
   The central coordinator can or cannot be installed directly in the company.
   Each user station (P) comprises:
means (P2) which are able to instantaneously display the technical data in graphical form and means (P3) which are able to analyze said data by specific scripts;
means (P4) which are able to program and download messaging scripts to a device (D) provided with display means, according to a proprietary protocol: for example logic scripts for searches for faults (threshold detection, relationship between several states of the sensor and the evolution of a pressure curve, etc.).
   The system also integrates a set of functionalities which are compatible with each other and interchangeable (modularity). They correspond for example to a hardware peripheral or to a particular procedure.
   The device (D) also comprises:
means for management of the machine faults and means for management of the system faults: the first making it possible to immediately report a fault resulting from a machine fault (pressure fault, temperature fault, etc.) and the second reporting a fault resulting from a fault in the embedded electronics (memory fault, GPS module fault, etc.);
means for opening a work session in order to access all the hardware peripherals or particular procedures.
specialized connections:
encrypted data: SSL protocol for the transfer of secured data
multimedia: image & audio processing protocol.
   It is connected to the machine by means of the following elements:
serial communication connections (RS232, RS422, RS485, IR)
dedicated boards (analogue input, TOR inputs, analog outputs, etc.)
TCP-IP port.
   It is connected to the central coordinator by means of the TCP-IP network using the following technologies: GPRS->Internet, U MTS->Internet, WIFI->gateway_GPRS/UMTS->Internet, Zigbee->gateway_GPRS/UMTS->Internet.
   The coordinator (C) also comprises:
a machine connection server: this service is provided to the machines in order to process all the orders which are intended for them, each machine having access to the common database and to a subdirectory in order to create saving files;
a user connection server: this service is provided to the users in order to communicate with one or more chosen machines, each user having access to the common database and the subdirectory in order to read the saving files;
a coordinator core: the latter coordinates all of the operations to be carried out between the users and the machines or between the machines themselves.
   It has the following additional functionalities:
multiserver: the purpose of this functionality is to permanently calculate the hardware resources used in order to offload certain tasks onto a coordinator of the “slave” type, this principle leading to the cascading of several coordinators;
maintenance: the maintenance channel makes it possible to access system information in order to precisely study the behaviour of the coordinator and of the connections between machine <->coordinator and user <->coordinator;
saving of secured data: this module makes it possible to duplicate all of the saved data in order to transfer them to other “providers”;
management of the fault messages: this module manages all of the faults to be reported.
   Their reporting can occur at the level of the users, by e-mail, by audible or visual alarms or by SMS.
   The station (P) also comprises:
means making it possible to open a work session in order to access to: the files saved at the level of the coordinator, the coordinator database, and a selected machine;
specialized connections:
encrypted data: SSL protocol for transfer of secured data
multimedia: image & audio processing protocol.
   Of course, the invention is not limited to the embodiments described and represented, other variants of which can be envisaged and in particular as regards:
the type, the functionalities, the number and the location of the machine devices and the user stations;
the type and the functionalities of the central coordinator;
the communication protocols between the different components of the system; without however exceeding the scope of the invention.

1. Method for managing and linking machines with users or other machines which are remote, intended to collect and process technical data provided by said machines, comprising:
capture of technical data by at least one machine device (D) connected to a given machine,
at least one so-called machine communication which is remote and wireless, between a machine device (D) and a central coordinator (C), of the IP server type,
at least one so-called user communication which is remote, between a user station (P) belonging to a user and the central coordinator (C), and
saving data,
characterized in that it further comprises an implementation, at the level of each machine device and of each user station, of a proprietary communication protocol comprising:
a permanent maintenance of each machine communication,
a permanent maintenance of each user communication,
reducing the volume of data, and
securing the saving of data.

2. Method according to claim 1, characterized in that it further comprises a dialogue of one or more users with one or more machines.

3. Method according to claim 1, characterized in that the saving of data comprises a recording of technical data and of associated timestamping data.

4. Method according to claim 1, characterized in that the saving of data comprises:
a transmission, by machine communication, of technical data to the central coordinator, and
recording the data in a common database and/or in a subdirectory for the creation of saving files.

5. Method according to claim 1, characterized in that securing the saving comprises:
a detection of a fault of a machine communication between a machine device and the central coordinator,
a local recording of technical data at the level of the machine device while the machine communication is faulty, then
once the machine communication is no longer faulty, a transmission to the central coordinator of the data recorded locally, and
recording the data in a common database and/or in a subdirectory for the creation of saving files.

6. Method according to claim 1, characterized in that the reduction of data volume comprises a cyclical implementation of the saving of the data.

7. Method according to claim 6, characterized in that the saving of the data records data only if said data are different from those recorded previously.

8. Method according to claim 1, characterized in that the reduction of data volume comprises an encoding of variation of at least one item of data on less than four octets.

9. Method according to claim 1, implemented for a group of machines comprising at least one or more mobile machines, characterized in that it comprises locating at least one mobile machine, and a transmission to the central coordinator (C) of location data.

10. Method according to claim 9, characterized in that it further comprises a calculation of the instantaneous speed of at least one mobile machine.

11. Method according to claim 9, characterized in that it further comprises an analysis by the central coordinator of geographical zones of the location data.

12. Method according to claim 1, characterized in that it further comprises:
an establishment, at the level of a machine device (D), of a correspondence between technical data originating from a given machine and an exchange table between the device (D) and the coordinator (C), and
a transfer of said exchange table to said coordinator.

13. Method according to claim 1, characterized in that it further comprises the establishment, at the level of the central coordinator (C), of a correspondence between technical data originating from a given machine and an exchange table between a machine device (D) connected to the machine and the coordinator (C).

14. Method according to claim 1, characterized in that it further comprises:
writing, at the level of the central coordinator (C), of fault-detection and adjustment scripts,
sending said scripts to a machine device (D), and
executing said scripts at the level of the machine device.

15. Method according to claim 1, characterized in that it further comprises, at the level of the central coordinator (C), a programming and/or a downloading of messaging scripts to a machine device (D) and a management of acknowledgements.

16. Method according to claim 1, characterized in that it further comprises, at the level of the central coordinator (C), a programming and/or a downloading of scripts intended to automatically establish a link between machines.

17. Method according to claim 1, characterized in that it further comprises a display on at least one user station (P), of the technical data in graphical form or an analysis of said data by specific scripts.

18. Method according to claim 1, characterized in that it further comprises, at the level of at least one user station (P), a programming and/or a downloading of messaging scripts to a machine device (D) according to a proprietary protocol.

19. System for managing and linking machines with users or other machines which are remote, using a method according to claim 1, and intended to collect and process technical data provided by said machines, comprising:
at least one machine device (D), connected to a given machine, comprising remote communication means and means for connection to data sensors which said machine is equipped with;
at east one user station (P) belonging to a user and comprising remote communication means; and
a central coordinator (C), of the IP server type, connected via communication means to said machine device(s) (D) and to the user station(s) (P), characterized in that:
each machine device (D) further comprises means (Dl) for generating algorithms intended to permanently maintain a wireless communication according to a proprietary communication protocol;
each user station (P) comprises means (P1) for generating algorithms intended to permanently maintain a communication according to a of proprietary communication protocol;
the central coordinator (C) comprises first server means (C1) arranged to allow an access for each machine device to a common database (B1) and to a subdirectory for the creation of saving files, and seconds server means (C2) arranged to allow one or more users to dialogue with one or more selected machines and to access the common database (B1) and the subdirectory in order to read the saving files; and
the system also comprises means for securing the saving of data and for reducing the data volume.

20. System according to claim 19, characterized in that the means for securing the saving include for each machine device (D) means (D2) for recording and timestamping technical data originating from the machines.

21. System according to claim 20, characterized in that the recording and timestamping means (D2) are arranged in order to carry out a cyclical recording.

22. System according to claim 21, characterized in that the recording and timestamping means (D2) are arranged to record data only if said data are different from those recorded previously.

23. System according to claim 19, implemented for a group of machines comprising at least one or more mobile machines, characterized in that the machine device (D) of each mobile machine further comprises means (D3) for locating said mobile machine and for transmitting location data to the central coordinator (C).

24. System according to claim 23, characterized in that the locating means are arranged to calculate the instantaneous speed of the mobile machine.

25. System according to claim 23, characterized in that the central coordinator (C) further comprises means (C3) for analyzing the geographical zones location data and interacting as a function of the information which will have been given to it.

26. System according to claim 19, characterized in that each machine device (D) further comprises means (D4) for establishing a correspondence between technical data originating from a given machine and an exchange table between said device (D) and the coordinator (C) and for transferring said exchange table to said coordinator.

27. System according to claim 19, characterized in that the central coordinator (C) further comprises means (C4) for establishing a correspondence between technical data originating from a given machine and an exchange table between a machine device (D) connected to the machine and the coordinator (C).

28. System according to claim 19, characterized in that the central coordinator (C) also comprises means (C5) for writing fault-detection and adjustment scripts and sending them to a machine device (D), in order to remotely execute them there.

29. System according to claim 19, characterized in that the central coordinator (C) also comprises means (C6) for programming and downloading messaging scripts to a machine device (D) provided with a display means of the interactive type or another type, and for managing acknowledgements.

30. System according to claim 19, characterized in that the central coordinator (C) comprises means which are able to program and download scripts intended to automatically establish a link between machines.

31. System according to claim 19, characterized in that each user station (P) comprises means (P2) which are able to instantaneously display the technical data in graphical form and means (P3) which are able to analyze said data by specific scripts.

32. System according to claim 19, characterized in that each user station (P) comprises means (P4) which are able to program and download messaging scripts to a machine device (D) provided with display means of the interactive type or another type, according to a proprietary protocol.

33. System according to claim 19, characterized in that the central coordinator is installed directly in the company.

34. System according to claim 19, characterized in that at least one of the machines is a factory production machine, mobile handling machine, a production robot, or an analysis, storage or preservation machine.
